(19) United States
(12) Patent Application Publication
(10) Pub. No.: US 2021/0110397 A1
(43) Pub. Date: Apr. 15, 2021

(54) SYSTEMS AND METHODS FOR USE IN PROVIDING IDENTITY SERVICES

(71) Applicant: MASTERCARD INTERNATIONAL INCORPORATED, PURCHASE, NY (US)

(72) Inventors: Daniel Brian O'Sullivan, White Plains, NY (US); Ashfaq Kamal, Stamford, CT (US)

(21) Appl. No.: 17/069,475

(22) Filed: Oct. 13, 2020

Related U.S. Application Data
(60) Provisional application No. 62/914,706, filed on Oct. 14, 2019.

(51) Int. Cl. G06Q 20/40

(52) U.S. Cl. CPC G06Q 20/4014

(57) ABSTRACT

Systems, devices and methods are described herein for verifying digital identities. One exemplary method includes receiving a request for verification from a relying party where the request includes a query related to an attribute of an identity of a user and a MPAN specific to the user. The method also includes identifying at least one verification party enrolled for the user and, when the at least one verification party includes sufficient information to respond to the query, converting the MPAN to an AgencyPAN associated with the at least one verification party. The method then includes submitting the query along with the AgencyPAN to an interface processor associated with the at least one verification party, receiving a response to the query from the interface processor, and transmitting the response to the query to the relying party.

### CROSS-REFERENCE TO RELATED APPLICATION

This application claims the benefit of and priority to U.S. Provisional Application No. 62/914,706, filed Oct. 14, 2019. The entire disclosure of the above application is incorporated herein by reference.

### FIELD

The present disclosure is generally directed to systems and methods for use in providing identity verification services to users, and in particular, to systems and methods for use in verifying, to relying parties, attributes of identities of user through use of master numbers and agency numbers associated with verification parties offering the verification services.

### BACKGROUND

This section provides background information related to the present disclosure which is not necessarily prior art.

People are known to be associated with identities. And, the identities of the people are often verified, by relying parties, through one or more physical documents (e.g., driver's licenses, government issued cards, etc.) or other documents indicative of the identities or identifying information of the people. In connection therewith, the people are required to carry such documents with them to be presented to the relying parties. More recently, digital identities are known to include personal identifying information (PII) for people, which permits assessment, authorization, and/or authentication of the people through the digital identifies when interacting with relying parties in a virtual manner (e.g., through network-based applications, etc.). As such, the digital identities may be used by the people to interact with relying parties, for example, over the Internet.

### DRAWINGS

The drawings described herein are for illustrative purposes only of selected embodiments and not all possible implementations, and are not intended to limit the scope of the present disclosure.

FIG. 1 is an exemplary system of the present disclosure suitable for use in providing identity verification services to users;

FIG. 2 is a block diagram of a computing device that may be used in the exemplary system of FIG. 1;

FIG. 3 is an exemplary method, which may be implemented in connection with the system of FIG. 1, for enrolling verification parties to a user in connection with providing identity verification services to the user; and

FIG. 4 is an exemplary method, which may be implemented in connection with the system of FIG. 1, for providing verification of attribute(s) of user identities based on queries submitted to enrolled verification parties.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Users often rely on their identities for a variety of reasons, including, for example, to qualify for certain goods or services (e.g., to purchase alcohol, etc.), to establish new accounts, to be authenticated in general, etc. To provide evidence of their identities to relying parties, the users often provide physical documents to the relying parties. Uniquely, the systems and methods herein allow the users to permit verification parties to respond to identity queries from the relying parties. In particular, a user enrolls a verification party to a payment network service associated with verification of identity attributes, whereby the user receives a master payment account number (MPAN) and the verification party is assigned an AgencyPAN. Thereafter, a request by a relying party for verification of the user includes a query and the MPAN, which permits a payment network to identify the verification party, convert the MPAN to the AgencyPAN, and submit the query to the verification party (or an interface processor (e.g., the Mastercard® Interface Processor (MIP), etc.) associated therewith). The verification party (alone or in cooperation with the interface processor) responds to the query (based on the AgencyPAN or, potentially, taking into account personal identifying information (PII) associated therewith). The response is provided back to the relying party, whereby the relying party is permitted to proceed in interaction(s), if any, with the user, and rely on the response to the query to do so. In this manner, the user is provided a network-based solution to identity verification, which limits the exposure of the user's PII, while still permitting the relying party to gather information and/or verifications needed to further interact with the user.

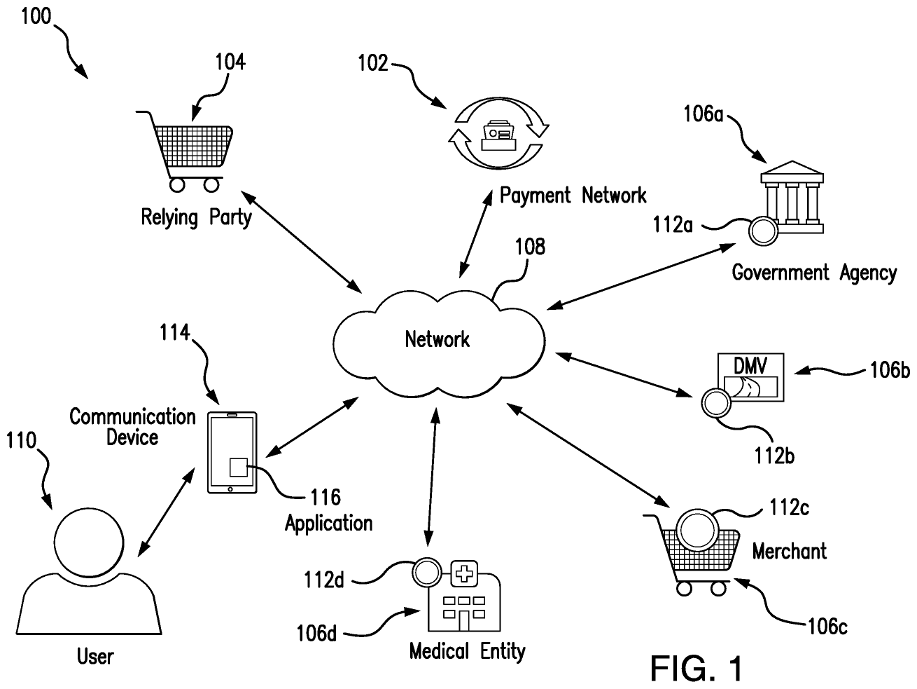

FIG. 1 illustrates an exemplary system 100, in which one or more aspects of the present disclosure may be implemented. Although the system 100 is presented in one arrangement, other embodiments may include the parts of the system 100 (or other parts) arranged otherwise depending on, for example, types of verification entities included in the system 100, privacy requirements implemented in the system 100; etc.

The illustrated system 100 generally includes a payment network 102, a relying party 104, and multiple verification parties 106a-d, each of which is associated with at least one computing device coupled to (and in communication with) a network 108. The network 108 may include one or more of, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

The payment network 102 in the system 100 is configured, conventionally, to facilitate payment account transactions between different parties in the system 100 (and others), such as, for example, consumers, merchants, etc. The payment account transactions are more particularly coordinated, by the payment network 102, between acquiring banks associated with merchants in the system 100 (e.g., merchant 106c, etc.), for example, and issuing banks associated with consumers in the system 100 (e.g., user 110, etc.), whereby funds are transferred to the merchants' accounts as issued by the acquiring banks from the consumers' accounts at the issuing bank. As part thereof, the payment network 102 is configured to coordinate authorization messaging (e.g., pass authorization messages, etc.) for payment account transactions between the merchants and the issuing banks (via the acquiring banks) (or through payment service providers on behalf of the banks), clear the transactions among the acquiring and issuing banks, and further settle funds therebetween, consistent with a conventional four-party payment scheme. In connection therewith, the authorization messaging typically includes payment account numbers (PANs) for payment accounts used in the payment account transactions (e.g., for payment accounts issued to consumers by issuing banks, whereby the consumers initiate the payment account transactions at the merchants using the payment accounts; etc.), and where the PANs for the payment accounts typically each have a specific format (e.g., each PAN may include a specific number of characters (e.g., at least sixteen digits, less than sixteen digits, etc.), etc.).

The relying party 104 in the system 100 includes, in this exemplary embodiment, a merchant offering products (e.g., goods, services, etc.) for sale online, whereby the merchant desires to confirm at least one attribute of consumers, such as the user 110, prior to or as part of a payment account transaction therewith (where the user 110 may or may not physically be present at the relying party 104). In one example, the merchant relying party 104 is a bar offering alcoholic beverages for sale, whereby the user 110 would need to be of a certain age to purchase such alcoholic beverages. Apart from this example, it should be understood that the relying party 104 may desire and/or be required to verify any attribute or multiple attributes of the user 110 as part of a payment account transaction (or, potentially, another interaction) with the user 110 (and where the user 110 may not be physically present at the relying party 104). It should further be appreciated that the relying party 104 may not include a merchant at all, but instead may be an entity that desires and/or is required to verify an attribute of the user 110 prior to engaging in any interactions with the user 110, prior to permitting the user 110 to enter a location, or confirming that the user 110 has not recently travelled to a high risk country (e.g., for purposes of giving blood, etc.), etc. (again, where the user 110 is not physically present at the relying party 104). However, in at least one embodiment, the present disclosure may be applied by a relying party 104 where the user 110 is physically present at the relying party 104 (e.g., to confirm one or more identity attributes of the user 110, etc.).

The user 110 referred to above is a person, who is associated with an identity, which includes multiple attributes. The attributes may include, for example, a name, contact information (e.g., an email address, a phone number, etc.), a physical address, a government ID number (e.g., a social security number, a driver's license number, a passport number, etc.), a gender, a biometric, a birthdate, an age, a birth place, a vehicle license plate number, a familial relationship (e.g., a mother's maiden name, etc.), a blood-type, a past address, licensing, memberships, travel information, details of and/or participants involved in transactions performed by the user 110 (e.g., a name of a mortgage lender, etc.), etc. It should be appreciated that an attribute of the user's identity may include any personal identifying information (PII) of the user 110, which is verifiable.

In addition, each of the attributes of the user 110 is verifiable with one or more of the verification parties 106a-d. In this exemplary embodiment, the verification party 106a includes a government agency (e.g., a state department, a department of revenue, a revenue service, a court, or another agency associated with public or private records, etc.). The verification party 106b includes a department of motor vehicles or DMV, and the verification party 106c includes a merchant. And, the verification party 106d includes a medical entity (e.g., a healthcare provider, a hospital, a medical insurance provider, etc.). It should be appreciated that additional and/or different verification parties (e.g., museums, membership entities (e.g., wholesale clubs, etc.), police departments, merchants, social networks, services providers (e.g., utility providers, etc.), etc.) may be included in other system embodiments.

With that said, the verification parties 106a-d in the system 100 are configured to have and to hold personal identifying information for the user 110 and other users, based on, for example, a purpose of the interactions of the verification parties 106a-d with the user 110 and/or other users, or otherwise. Table 1 includes an exemplary listing of attributes that may be held by each of the different verification parties 106a-d in the system 100 with respect to the user 110. Table 1 also includes exemplary queries that may be posed by the relying party 104 with regard to the different attributes of the user 110, and an indication of the particular one(s) of the verification parties 106a-d that are available (e.g., enrolled, etc.) to respond to the particular queries. Table 1 further includes a priority listing of the verification parties 106a-d for each of the attributes/queries, for example, when multiple ones of the verification parties 106a-d are available to respond to the given query, such that the particular one of the verification parties 106a-d selected to respond to the given query may be selected/identified based on the priority listing (e.g., where the priorities may be related to costs associated with the verification of the user 110 by the given one or more of the verification parties 106a-d, speed/efficiency associated with the verification of the user 110 by the given one or more of the verification parties 106a-d, a confidence in the verification of the user 110 by the given one or more of the verification parties 106a-d, etc.).

TABLE 1

| | | Available | Priority of |
|---|---|---|---|
| | | Verification | Verification |
| Attribute | Query | Party(ies) | Party(ies) |
| Age (or | Is the user 110 | Government | 1. DMV 106b |
| Birth Date) | over XX years old | agency 106a, | 2. Government |
| | or under XX years | DMV 106b, | agency 106a |
| | old? | medical | 3. Medical |
| | | records | records |
| | | entity 106d. | entity 106d |
| Driver's | Does the user 110 have | DMV 106b. | 1. DMV 106b |
| License | a valid driver's license, | | |
| Information | a vehicle registration, | | |
| | and an accident history? | | |
| Travel | Does the user 110 have | Government | 1. Government |
| Information | a valid passport, and | agency 106a. | agency 106a |
| | traveled to YY in the | | |
| | past ZZ months (where | | |
| | YY is a place and ZZ is | | |
| | an integer)? | | |
| Licensing | Does the user 110 have | Government | 1. DMV 106b |
| Information | a boating license, a | agency 106a, | 2. Government |
| | pilot's license, or a | DMV 106b. | agency 106a |
| | firearm license? | | |
| Membership | Is the user 110 an active | Merchant 106c. | 1. Merchant |
| Information | member? | | 106c |
| | Is the user 110 eligible | | |
| | for a discount? | | |
| Medical | Is the user 110 eligible | Medical | 1. Medical |
| Information | for medical benefits? | records | records |
| | Has the user 110 | entity 106d. | entity 106d |
| | reached his/her | | |
| | maximum out-of-pocket | | |
| | co-pay (Y/N and/or | | |
| | amount toward | | |
| | maximum)? | | |
| | Is the user 110 disabled | | |
| | (Y/N and/or status)? | | |

It should be appreciated that the attributes, the queries associated with the attributes, and the verification parties associated with the specific attributes (and/or their priorities) may be different than illustrated in Table 1 in other system embodiments. As described above, for example, any attributes associated with the identity of a user may be considered and/or included in embodiments of the system 100.

With continued reference to FIG. 1, each of the verification parties 106a-d is associated with and/or includes an interface processor 112 (e.g., the Mastercard® Interface Processor (MIP), etc.), which facilitates messaging between the payment network 102 and the verification parties 106a-d and/or between the relying party 104 and the verification parties 106a-d. In this exemplary embodiment, each of the interface processors 112a-d is located at one of the corresponding verification parties 106a-d (i.e., interface processor 112a is located at verification party 106a, etc.), but is an extension of the payment network 102 (and thus is not an actual part of the corresponding one of the verification parties 106a-d). And, each of the interface processors 112a-d is configured to interact with the payment network 102, as is described further below. In connection therewith, the interface processors 112a-d allow the corresponding verification parities 106a-d to interact with various private sectors (such as the relying party 104), where they may not typically have such ability (e.g., the government agency verification party 106a and the DMV verification party 106b may not be able to connect directly with a private sector such as the relying party 104, whereby the interface processors 112a-b then facilitate such connection/communication; etc.).

Also, as shown in FIG. 1, the user 110 is associated with a communication device 114, such as, for example, a smartphone, a tablet, etc. The communication device 114 in general is a portable communication device, which permits the user 110 to carry the communication device 114 from place to place. The communication device 114 includes a verification application 116 that includes computer-executable instructions, which are installed and active in the communication device 114, to configure the communication device 114 to operate as described herein (e.g., to facilitate verification of the user 110 as described herein, etc.).

At the outset in the system 100, the user 110 registers with the payment network 102, through the verification application 116 at the communication device 114, for the verification service described herein, whereby the user 110 is identified to the payment network 102. Once registered, the payment network 102 is configured to provision a master payment account number (or MPAN) to the user 110 (e.g., a sixteen-digit number, a number having another number of digits or another format, etc.). In turn, the communication device 114 is configured, by the application 116, to receive the MPAN and store the MPAN in memory therein. For instance, the communication device 114 may bind the MPAN as an identifier in a secure element of the communication device 114 (e.g., in a microprocessor chip of the communication device 114 configured to store sensitive data and run secure applications associated with the communication device 114, etc.). As part of the registration, the user 110 also agrees to permissions, limitations, terms and conditions associated with the protection, privacy and dissemination of the user's PII by and/or in connection with the verification parties 106a-d, generally or specifically.

After registration, the user 110 is able to enroll one or more of the verification parties 106a-d to his/her account (whereby the user 110 may then subsequently use the enrolled verification parties 106a-d to verify different attributes of the user 110). In particular, the user 110 accesses the verification application 116, in the communication device 114, whereupon the communication device 114 is configured, by the application 116, to offer an option, as part of an interface, for the user 110 to enroll a verification party for the user 110. Upon selection of the option, the communication device 114 is configured, by the application 116, to solicit identification of the verification party. Specifically, for example, the communication device 114 is configured, by the application 116, to display a listing of eligible verification parties (e.g., as identified by the payment network 102, etc.), or display a field that permits the user 110 to enter a specific verification party. In either case, upon selection (or entry) of one of the verification parties 106a-d of the system 100, for example, the communication device 114 is configured, by the application 116, to solicit an authentication input from the user 110, such as, for example, a biometric (e.g., a facial image, a fingerprint, etc.), a passcode, etc. In connection therewith, the user 110 may select/designate different ones of the verification parties 106a-d to verify different attributes of the user 110 (e.g., attributes for which the selected verification party may have information with regard to the user 110 based on a prior relationship and/or interaction with the user 110, etc.). For instance, the user 110 may designate the DMV verification party 106b to verify age/birth date attributes of the user 110, and the medical entity verification party 106d to verify a vaccination history of the user 110. With that said, it should be appreciated that the user 110 will typically only enroll ones of the verification parties 106a-d with which he/she has a relationship (e.g., the user 110 cannot enroll a foreign DMV verification party for age verification when he/she lives in the US and has no relationship with the foreign DMV verification party because the foreign DMV verification party will have no information relating to the user 110, etc.).

Upon receipt of the authentication input from the user 110, where the authentication input includes the biometric of the user 110, the communication device 114 is configured to covert or map the biometric to a biometric template (via a suitable algorithm, etc.). The communication device 114 is configured, by the verification application 116, to then transmit the authentication input (including the biometric template) to the payment network 102, along with a name and/or identifier (or selection) of one of the verification parties 106a-d identified by the user 110, for example, as part of a request to enroll the verification party (in general or for a particular attribute of the user 110, etc.). The request further includes, in this example, PII received by the communication device 114 from the user 110, such as a name, an address, a driver's license number, a passport number, etc. The PII may be solicited specifically by the payment network 102 and/or the application 116 based on the selected and/or entered verification party (e.g., a driver's license number may be requested from the user 110 when the DMV verification party 106b is selected, or a government ID number may be solicited from the user 110 when the government agency verification party 106a is selected, etc.). In this exemplary embodiment, the request is transmitted to the payment network 102 through an application programming interface (API) associated with the payment network 102. It should be appreciated that, in addition to transmitting the request, the API may also be involved in compilation of the request in connection with the application 116 at the communication device 114.

The payment network 102 is configured to receive the enrollment request from the communication device 114 and to identify (in an unconventional manner) the verification party indicated and/or selected in the request. In this example, the selected verification party in the enrollment request is the DMV verification party 106b. The payment network 102 is configured to then transmit an authentication request for the user's authentication input (as included in the enrollment request) to the interface processor 112b for the verification party 106b, for example, via the payment network API (or another API), etc. The authentication request, in general, includes the authentication input received from the user 110 and the PII of the user 110, such as, for example, a driver's license number in this example.

In response to the authentication request, the interface processor 112b is configured to request a reference for the authentication input from the verification party 106b, based on the PII associated with the user 110. For example, where the authentication input is a facial image (broadly, a biometric), the interface processor 112b is configured to submit a request for a biometric reference (e.g., an image included in the user's driver's license, etc.) along with the driver's license number of the user 110. In response, the verification party 106b may be configured to identify the user 110 based on the driver's license number (or other PII), to retrieve an image of the user 110 from the user's driver license, and to pass the data to the interface processor 112b. The interface processor 112b is configured to then authenticate the user 110 (e.g., by comparing the reference received from the verification party 106b to the authentication input included in the authentication request, etc.) and to report a result to the payment network 102, via the API, for example. For instance, the facial image of the user 110 received as the authentication input from the user 110 may be represented as a biometric template. And, the image of the user 110 retrieved from the user's driver's license may be similarly converted to a biometric template (via a suitable algorithm, etc.), whereby the two biometric templates may then be compared.

The payment network 102 is configured to then issue the MPAN to the user 110 at the communication device 114 (e.g., if not already done so upon initial registration of the user 110 to the verification service, etc.) and to issue an agency payment account number or AgencyPAN to the interface processor 112b associated with the verification party 106b (e.g., a sixteen-digit number, a number having another number of digits or another format, etc.). In turn, the payment network 102 is configured to store the MPAN and the AgencyPAN in memory thereof, and associate each of the MPAN and the AgencyPAN to one another. And, the communication device 114 is configured, by the application 116, to store the MPAN in secure memory therein. In particular, the communication device 114 binds the MPAN as an identifier in a secure element of the communication device 114 (e.g., in a microprocessor chip of the communication device 114 configured to store sensitive data and run secure applications associated with the communication device 114, etc.). Similarly, the interface processor 112b is configured to store the AgencyPAN in memory in association with (or bound to) the user's PII, such as, for example, the user's driver's license number, as known by the verification party 106b. In this manner, the verification party 106b is then enrolled and/or on-boarded to provide verification for the user 110 when requested.

While the above example is described with reference to the verification party 106b, it should be appreciated that enrolling and/or on-boarding the other verification parties 106a and 106c-d and/or interface processors 112a and 112c-d illustrated in FIG. 1 would take place in substantially the same manner. As part thereof, it should be appreciated that there will only be one MPAN, generally, per user (e.g., for the user 110, etc.), with each of the AgencyPANs for the interface processors 112a-d and/or verification parties 106a-d then associated with that one MPAN and the user 110. Of course, in one or more embodiments, the payment network 102 may be configured to issue a separate MPAN for each interface processor and/or verification party (per user), or for multiple interface processors and/or verification parties.

Next in the system 100, after enrollment, when the user 110 interacts with the relying party 104, e.g., a merchant website, etc., the relying party 104 may request verification of an attribute of the user 110, such as an age, membership status, licensure, etc. Verification of the attribute is generally provided, for example, in the form of a query similar to those included in Table 1. When the relying party 104 is a bar, for example, the attribute may include the age of the user 110 and the query may include “Is the User 110 Over 21?” or something similar. To provide the verification, the communication device is configured, by the application 116, to solicit authentication of the user 110 through an authentication input (e.g., a biometric input, etc.), as compared by the communication device 114 to the biometric template used during enrollment (either locally at the communication device 114 or centrally, for example, at the payment network 102 whereby the given biometric templates may be communicated to the payment network 102 for such comparison, etc. (e.g., depending on size of the biometric templates being compared, complexity of the comparison, security concerns, etc.)). When authenticated, the communication device 114 is configured, by the application 116, to access the MPAN therein and provide the MPAN to the relying party 104. For example, the communication device 114, via the application 116, may display the MPAN to the user 110 at the communication device 114, whereby the user 110 may then enter the MPAN to the website associated with the relying party 104, or display the MPAN to the relying party 104 (when the user 110 is present at the relying party 104), etc.

In turn, the relying party 104 is configured to submit a verification request, including the MPAN and the desired query relating to an attribute of the user 110 (relating to the age of the user 110 in the current example), to the payment network 102, via another API, as above, or through a financial or non-financial messaging of/through the payment network 102 (e.g., an ISO-based message, an ASI-based message, etc.). Upon receipt, the payment network 102 is configured to identify the user 110 based on the MPAN and to identify an enrolled one of the verification parties 106a-d suited to respond to the given query. The verification party may be identified, for example, based on the query and/or a prior association of a particular query with a verification party by the user 110 (and which association is stored (unconventionally) in memory of the payment network 102). Or, the verification party may be identified based on a predefined association, such as shown in Table 1 (whereby one or more priorities of the verification parties 106a-d may also be implemented when multiple ones of the verification parties 106a-d are available to respond to the given query (e.g., where the priorities may be related to costs associated with the verification of the user 110 by the given one or more of the verification parties 106a-d, speed/efficiency associated with the verification of the user 110 by the given one or more of the verification parties 106a-d, a confidence in the verification of the user 110 by the given one or more of the verification parties 106a-d, etc.)), and again which association is stored (unconventionally) in memory of the payment network 102. When the appropriate verification party is identified (e.g., the verification party 106b in the above example, etc.), the payment network 102 is configured to identify the AgencyPAN based on the MPAN (e.g., converts the MPAN to the AgencyPAN based on the prior association of the two, etc.), as issued during enrollment, and to submit a verification request to the interface processor 112b associated with the identified verification party 106b (including the AgencyPAN for the identified verification party 106b). The request may be submitted through an API, as above, or through a financial or non-financial messaging of the payment network 102.

The interface processor 112b, in response to the verification request from the payment network 102, is configured to identify the user 110 based on the AgencyPAN and to map the AgencyPAN to the available PII known to the verification party 106b for the user 110, which in this example is a driver's license number for the user 110. The interface processor 112b is then configured to request a response to the query from the verification party 106b (relating to the age of the user 110, and whether the user 110 is over 21 years old), with the request including the driver's license number. The verification party 106b is configured to identify the user 110 based on the driver's license number (broadly, based on the user's PII) and to determine a response to the query based on the PII of the user 110 known to the verification party 106b (e.g., YES/NO, etc.), and then to transmit the response to the interface processor 112b. The interface processor 112b, in turn, is configured to provide the response to the payment network 102, which is configured to provide the response to the relying party 104.

Based on the response to the query, the relying party 104 may determine whether or not to continue in a given interaction with the user 110. For instance, in the above example where the relying party 104 is a merchant offering products (e.g., goods, services, etc.) for sale online, the query may relate to whether or not the user 110 is twenty-one years of age. When the response from the verification party 106b confirms that the user 110 is twenty-one years of age, the relying party 104 may allow the user 110 to complete the given transaction for the selected products. In so doing, the user 110 may provide a payment account number for a payment account to the relying party 104, for funding the transaction, and the relying party 104 may generate an authorization request for the transaction (including the payment account number for the user's payment account). The relying party 104 then transmits the authorization request to the payment network 102 (via an acquiring bank associated with the relying party 104) in a conventional manner, and the payment network 102 then routes the authorization request to an issuing bank associated with the user's payment account (for approving or declining the transaction) again in a conventional manner. With that said, it should be appreciated that the payment account number provided by the user 110 to the relying party 104 to initiate the transaction may be different than the MPAN used to request verification of the user. Or, the MPAN and the payment account number for the user's payment account may be the same (e.g., the MPAN may be a same number as the payment account number for the user's payment account, etc.).

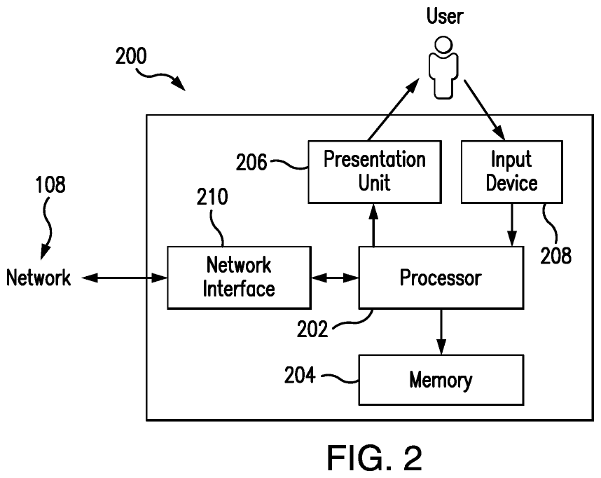

FIG. 2 illustrates an exemplary computing device 200 that can be used in the system 100 of FIG. 1. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, each of the payment network 102, the relying party 104, the verification parties 106a-d, and the interface processors 112a-d includes and/or is implemented in one or more computing device consistent with the computing device 200, coupled to (and in communication with) the network 108. In addition, the communication device 114 should be understood to be a computing device generally consistent with computing device 200. With that said, it should be appreciated that the system 100 is not limited to the computing device 200, as described below, as different computing devices and/or arrangements of computing devices may be used in other embodiments.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, MPANs, AgencyPANs, PII, biometrics, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. It should be appreciated that the memory 204 may include a variety of different memories, each implemented in one or more of the functions or processes described herein.

The computing device 200 also includes a presentation unit 206 that is coupled to (and is in communication with) the processor 202 (however, it should be appreciated that the computing device 200 could include output devices other than the presentation unit 206, etc. in other embodiments). The presentation unit 206 outputs information (e.g., prompts to select a verification party to enroll, prompts to authenticate inputs, etc.), visually or audibly, for example, to a user of the computing device 200 (e.g., user 110 associated with the communication device 114, etc.), etc. And various interfaces may be displayed at computing device 200, and in particular at presentation unit 206, to display certain information in connection therewith. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user of the computing device 200 (i.e., user inputs) such as, for example, biometrics, selections, entries, etc., as further described herein. The input device 208 may include a single input device or multiple input devices. What's more, the input device 208 is coupled to (and is in communication with) the processor 202 and may include, for example, one or more of a keyboard, a pointing device, a camera, a touch sensitive panel, another computing device, and/or an audio input device. In various exemplary embodiments, a touch screen, such as that included in a tablet, a smartphone, or similar device, may behave as both the presentation unit 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter, mobile network adapter, or other device capable of communicating to the network 108 and/or with other devices described herein. In some exemplary embodiments, the computing device 200 may include the processor 202 and one or more network interfaces incorporated into or with the processor 202.

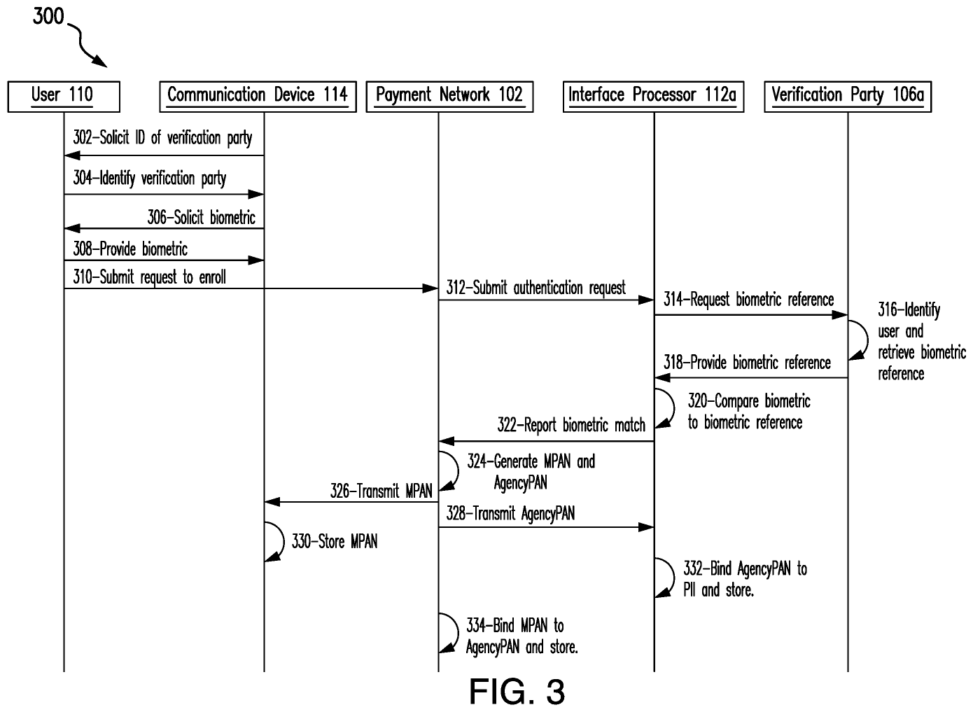

FIG. 3 illustrates an exemplary method 300 for enrolling a verification party for a user. The exemplary method 300 is described as implemented in the communication device 114 (inclusive of the verification application 116), the payment network 102, the interface processor 112a, and the verification party 106a of the system 100. Reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the exemplary method 300.

At the outset in the method 300, the user 110 desires to enroll or onboard a verification party to provide verification of attributes of the user's identity as needed. In connection therewith, the method 300 is described below with reference to the verification party 106a and the corresponding interface processor 112a. It should be appreciated, though, that the method 300 similarly applies to any of the other verification parties 106b-d, and also to any of the other interface processors 112b-d, whereby the user 110 could similarly enroll the other ones of the verification parties 106b-d as desired.

At 302 in the method 300, the communication device 114 (as directed by the verification application 116, for example) solicits identification of a verification party from the user 110, which may include soliciting a selection of a particular one of the verification parties 106a-d (e.g., via a drop-down menu, etc.) or entry of a name associated with one of the verification parties 106a-d. In either case, in response, at 304, the user 110 identifies the verification party 106a. Again, the user 110 may select/designate different ones of the verification parties 106a-d to verify different attributes of the user 110 (and thereby enroll multiple of the verification parties 106a-d so that they can provide the desired attribute verifications). For instance, in connection with enrolling the verification party 106a herein, the user 110 may designate the verification party 106a to verify citizenship/residency attributes and/or travel attributes of the user 110, as necessary.

Next, the communication device 114 solicits a biometric (broadly, an authentication input) from the user 110, at 306. And, at 308, the user 110 provides the biometric to the communication device 114, which captures the same via an input device 208, etc. The biometric may include, for example, a selfie or facial image of the user 110, which is captured, by the communication device 114, via a camera input device 208, etc. In addition to the biometric, the communication device 114 and/or the payment network 102 (e.g., via the verification application 116 of the communication device 114, etc.) may solicit further information about the user 110 and/or the verification party 106a, when the verification party 106a is identified. For example, the communication device 114 may further solicit a driver's license number, a government ID number, a membership number, a passport number or other PII (depending on the particular one of the verification parties 106a-d being enrolled), which may ultimately be used by the verification party 106a to identify the user 110, as described below.

In turn, the communication device 114 compiles and submits, at 310, a request to the payment network 102 to enroll the verification party 106a for the user 110 (via an API associated with the payment network 102, etc.). The request includes, generally, the captured biometric for the user 110, the identification of the verification party 106a, and any PII solicited from the user 110, or a part thereof. In connection therewith, the communication device 114 may convert or map the captured biometric for the user 110 to a biometric template (via a suitable algorithm, etc.), and then append the biometric template to the request to submit to the payment network 102. In so doing, the communication device 114 may also append a time-stamp or some other verification to the request indicating that the captured biometric was captured recently and is authentic (e.g., is not a copy, was not captured from a stored photo, etc.).

Upon receipt of the request, the payment network 102 identifies the verification party 106a (from the request) and submits, at 312, the biometric (for example, the biometric template from the request) for the user 110 to the interface processor 112a associated with the verification party 106a (as an authentication request) for authentication by the verification party 106a (e.g., via an API, etc.). In connection therewith, the interface processor 112a requests, at 314, a biometric reference from the verification party 106a for the user 110. As part of the request, the interface processor 112 provides the PII, or part thereof, supplied by the user 110, to the verification party 106a. In turn, the verification party 106a identifies the user 110 from the PII and retrieves a biometric reference for the user 110, at 316. The biometric reference may be pulled from a driver's license or passport record of the verification party 106a (e.g., in the form of an image of the user 110, etc.), or from a source of fingerprints for the user 110 (or a source of retina scans, voice scans, vein maps, etc.), or otherwise (e.g., from another verified source, etc.). Then, at 318, the verification party 106a provides the biometric reference to the interface processor 112a.

Then, the interface processor 112a compares, at 320, the biometric received in the authentication request (from the payment network 102) to the biometric reference received from the verification party 106a (e.g., after converting the biometric reference received from the verification party 106a to a corresponding biometric template (if not already done by the verification party 106a), etc.). When there is a sufficient or substantial match, per industry standards, the interface processor 112a reports the match to the payment network 102, at 322. In turn, the payment network 102 generates an MPAN and an AgencyPAN, at 324. In general, the MPAN and the AgencyPAN will be in a format that is generally consistent with payment account numbers for payment accounts supported by the payment network 102 in connection with processing payment account transactions (e.g., a standard 16-digit ISO format that is the same format as a PAN for a payment card, etc.). As can be appreciated, this may allow the payment network 102 to easily and efficiently rout the MPAN and the AgencyPAN as appropriate via conventional network messaging (e.g., via conventional authorization messages transmitted through the payment network 102 from relying parties and/or to verification parties consistent with the ISO 8583 standard (or other suitable standard), etc.) (e.g., without requiring use of a new/different standard that would require new processing rules to avoid the MPAN and/or the AgencyPAN from being filtered out of authorization messaging or other messaging facilitated through the payment network 102 as having improper formats, etc.). That said, however, it should be appreciated that the MPAN and/or the AgencyPAN may have different formats in other embodiments (e.g., formats other than the standard 16-digit ISO format, etc.). The payment network 102 further transmits the MPAN to the user 110 at his/her communication device 114, at 326, and transmits the AgencyPAN to the interface processor 112a, at 328. As shown, the communication device 114 stores, at 330, the MPAN in memory (e.g., memory 204, etc.) (e.g., in a secure element accessible after authentication, etc.). Similarly, the interface processor 112a binds the AgencyPAN to the PII provided to the verification party 106 (e.g., the driver's license number, the passport number, etc.) and stores the AgencyPAN in memory (e.g., memory 204, etc.), at 332. And finally, at 334, the payment network 102 binds the MPAN to the AgencyPAN and stores the same in memory (e.g., memory 204, etc.).

Conversely in the method 300, if there is not a match, at 318, between the biometric for the user 110 received in the authentication request (from the payment network 102) and the biometric reference received from the verification party 106a, the interface processor 112a informs the payment network 102 accordingly, whereupon the enrollment is declined.

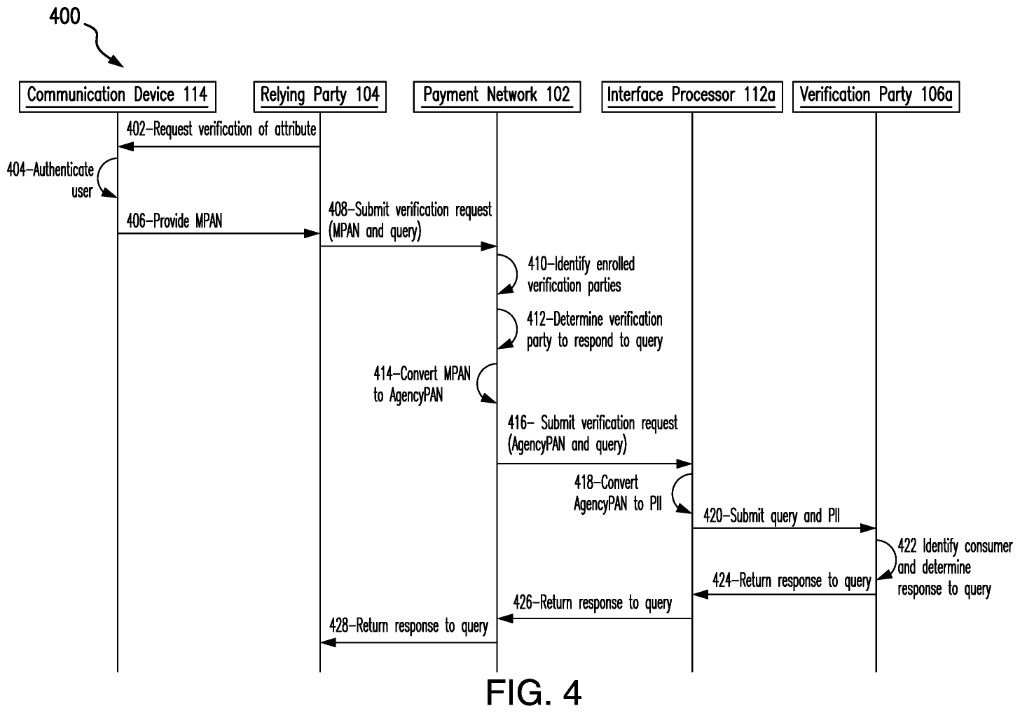

FIG. 4 illustrates an exemplary method 400 for verifying an attribute of a user with a verification party. The exemplary method 400 is described as implemented in the communication device 114 (inclusive of the application 116), the relying party 104, the payment network 102, the verification party 106a, and the interface processor 112a of the system 100. Reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the exemplary method 400. It should also be appreciated that the method 400 similarly applies to any of the other verification parties 106b-d, and also to any of the other interface processors 112b-d, whereby the user 110 could similarly rely on the other ones of the verification parties 106b-d for verifying an attribute, as desired (and when the other ones of the verification parties 106b-d are properly enrolled, for example, as described in method 300).

After enrollment, as described above, the user 110 interacts with the relying party 104, such that the relying party desires and/or is required to verify an attribute about the user 110 (e.g., is the user 110 a citizen of the U.S., etc.). In connection therewith, the relying party 104 requests, at 402, verification of an attribute of the user 110 at the communication device 114 associated with the user 110 (e.g., at the verification application 116, etc.).

In turn, the communication device 114 authenticates the user 110, for example, through capturing and comparing a biometric of the user 110, at 404, and then, when authenticated, provides the MPAN for the user 110 to the relying party 104, at 406 (e.g., presents the MPAN to the user 110 via the presentation unit 206 of the communication device 114, whereby the user 110 may then enter the MPAN to the website associated with the relying party 104, etc.). Upon receipt of the MPAN, the relying party 104 submits a request for verification (i.e., a verification request), at 408, which includes the MPAN and a query specific to the desired verification to the payment network 102 (e.g., “Is the user 110 a U.S. citizen?, etc.).

In response, the payment network 102 initially identifies the request as a verification request, for example, as opposed to an authorization request for a payment account transaction (for which the verification request may have the same messaging format). This may be done based on one or more digits included in the MPAN (such as the first four digits of the MPAN), based on an merchant category code specific to the verification parties 106a-d, etc. The payment network 102 then identifies the enrolled ones of the verification parties 106a-d for the user 110 (based on a user ID associated with the MPAN, etc.), at 410, and determines, at 412, which of the enrolled verification parties 106a-d for the user 110 is suited to respond to the query (e.g., verification party 106a in this example, etc.). The payment network 102 may, for example, determine the appropriate one of the verification parties 106a-d from a table (e.g., a look-up table, a data structure, etc. accessible to the payment network 102; etc.), such as Table 1, which includes a listing of the attributes known to the verification parties 106a-d, which are responsive to specific queries. In connection therewith, the payment network 102 may identify the verification party 106a to respond to the query by the relying party 104 as to whether or not the user 110 is a U.S. citizen. The payment network 102 then converts the MPAN to the AgencyPAN for the determined verification party 106a, at 414, which may also be done by way of a look-up table or other data structure. And, in turn, the payment network 102 submits a request for verification to the interface processor 112a associated with the determined verification party 106a, at 416 (including the AgencyPAN for the verification party 106a and desired query).

The interface processor 112a, in response to the request, converts the AgencyPAN to the PII for the user 110 (broadly, maps the AgencyPAN to the PII for the user 110 provided by the user 110 during enrollment of the verification party 106a), such as, for example, a driver's license number, a passport number, etc., at 418. The interface processor 112 then submits the query and the PII to the verification party 106, at 420. In turn, the verification party 106a identifies the user 110 based on the PII and determines a response to the query, at 422. In particular, the verification party 106a may search for the PII in a data structure of PII included in memory, and retrieve all PII associated with the PII (e.g., driver's license number, citizenship status, etc.). The verification party 106a is then able to rely on any of the PII (such as, for example, birthdate for age queries, driver's license records for licensure queries or registration queries, travel destination for travel queries, birthplace for citizenship inquirers, etc.) to determine a response to the query.

When a response is determined, the verification party 106a returns, at 424, the response to the query to the interface processor 112a associated therewith, which, in turn, returns the response to the query to the payment network 102, at 426. And finally, at 428, the payment network 102 returns the response to the query to the relying party 104. Thereafter, the relying party 104 may continue interacting with the user 110 and rely on the verification of the attribute of the identity of the user 110 to do so.

In view of the above, the systems and methods herein permit users to enable verification parties to provide verification of attributes to relying parties, when the attributes are known to the verification parties. In this manner, identities of users may be maintained at verification parties, and not proliferated to relying parties, such as, for example, merchants, while still permitting relying parties to verify attributes of users' identities. This serves to limit exposure of PII, and as a result, protects the users from identity theft and/or fraud.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations and/or at least one of the operations recited in the claims: (a) receiving, at a computing device, a request for verification from a relying party, the request including a query related to an attribute of an identity of a user interacting with the relying party and a master payment account number (MPAN) specific to the user; (b) identifying, by the computing device, a verification party enrolled for the user; (c) determining, by the computing device, whether the verification party includes information sufficient to respond to the query; (d) when the verification party includes sufficient information to respond to the query, converting, by the computing device, the MPAN to an agency payment account number (AgencyPAN) associated with the verification party; (e) submitting, by the computing device, the query along with the AgencyPAN to an interface processor associated with the verification party; (f) receiving, by the computing device, a response to the query from the interface processor; and (g) transmitting, by the computing device, the response to the query to the relying party.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in verifying attributes of user identities, the method comprising:
receiving, at a computing device, a request for verification from a relying party, the request including a query related to an attribute of an identity of a user interacting with the relying party and a master payment account number (MPAN) specific to the user;
identifying, by the computing device, a verification party enrolled for the user based at least in part on the MPAN;
determining, by the computing device, whether the verification party includes information sufficient to respond to the query;
when the verification party includes sufficient information to respond to the query, converting, by the computing device, the MPAN to an agency payment account number (AgencyPAN) associated with the verification party;
submitting, by the computing device, the query along with the AgencyPAN to an interface processor associated with the verification party;
receiving, by the computing device, a response to the query from the interface processor; and
transmitting, by the computing device, the response to the query to the relying party.

2. The computer-implemented method of claim 1, wherein the computing device is included in a payment network configured to pass authorization messages for payment account transactions between merchants and banks, the authorization messages each including a payment account number having a specific format; and
wherein the MPAN and the AgencyPAN each has the specific format, whereby, based on said specific format, the MPAN and the AgencyPAN are consistent with a payment account number to the payment network.

3. The computer-implemented method of claim 2, wherein the specific format includes at least sixteen characters.

4. The computer-implemented method of claim 2, further comprising:
receiving, by the computing device, an authorization request for a transaction by the user at the relying party to a payment account, after transmitting the response to the query to the relying party, wherein a payment account number for the payment account is different than the MPAN; and
transmitting, by the computing device, the authorization request to an issuer associated with the payment account.

5. The computer-implemented method of claim 1, wherein determining whether the verification party includes information sufficient to respond to the query includes determining that the verification party includes information about the attribute of the identity of the user based on a linking of the attribute to the verification party in a data structure associated with the computing device.

6. The computer-implemented method of claim 5, wherein the data structure includes multiple verification parties enrolled for the user and associated with the attribute of the identity of the user; and
wherein determining whether the verification party includes information sufficient to respond to the query further includes identifying the verification party from the multiple verification parties based on a priority order of the verification party relative to the multiple verification parties.

7. The computer-implemented method of claim 1, further comprising:
receiving, by the interface processor, the query and the AgencyPAN from the computing device; and
converting, by the interface processor, the AgencyPAN to personal identifying information and transmitting the personal identifying information and the query to the verification party, thereby permitting the verification party to use the personal identifying information for the user to identify the user and compile the response to the query.

8. The computer-implemented method of claim 1, further comprising, prior to receiving the request for verification from the relying party, enrolling, by the computing device, the verification party to the user;
wherein enrolling the verification party to the user includes:
receiving, from the user, a request to enroll the verification party to the user, the request to enroll the verification party including a sample biometric for the user and personal identifying information for the user;
transmitting, by the computing device, the sample biometric and the personal identifying information for the user to the interface processor associated with the verification party;
receiving, at the computing device, verification of the sample biometric for the user;
generating the MPAN and the AgencyPAN based on the verification of the sample biometric for the user; and
transmitting the AgencyPAN to the interface processor associated with the verification party and transmitting the MPAN to a computing device associated with the user.

9. The computer-implemented method of claim 8, wherein the personal identifying information for the user corresponds to personal identifying information for the user stored at and known to the verification party, whereby the verification party is able to identify the user and retrieve a reference biometric for the user based at least in part on matching the personal identifying information included in the request to enroll the verification party with the personal identifying information for the user stored at and known to the verification party, thereby permitting the verification party and/or the interface processor associated with the verification party to use the reference biometric to verify the sample biometric for the user.

10. A system for use in verifying attributes of user identities, the system comprising:
a data structure having a master payment account number (MPAN) for a user and an agency payment account number (AgencyPAN) linked to the MPAN and associated with a verification party enrolled for the user; and
a payment network computing device in communication with the data structure, the payment network computing device configured to:
receive a request for verification of the user from a relying party interacting with the user, the request including a query related to an attribute of an identity of the user and the MPAN for the user;
identify, in the data structure, the verification party enrolled for the user based on the MPAN;
determine that the verification party includes information about the user sufficient to respond to the query;
convert the MPAN to the AgencyPAN associated with the verification party based on the link between the MPAN and the AgencyPAN in the data structure;
submit the query along with the AgencyPAN to an interface processor associated with the verification party; and
receive a response to the query from the interface processor and transmit the response to the relying party.

11. The system of claim 10, wherein the payment network computing device is further configured to pass authorization messages for payment account transactions between merchants and banks, the authorization messages each including a payment account number having a specific format; and
wherein the MPAN and the AgencyPAN each has the specific format, whereby, based on said specific format, the MPAN and the AgencyPAN are consistent with a payment account number to the payment network computing device.

12. The system of claim 10, further comprising the interface processor;
wherein the interface processor is configured to:
receive the query and the AgencyPAN from the payment network computing device in connection with the request for verification of the user by the verification party;
convert the AgencyPAN to personal identifying information for the user stored at and known to the verification party;
transmit the personal identifying information and the query to the verification party, thereby permitting the verification party to use the personal identifying information for the user to identify the user and compile the response to the query;
receive the response from the verification party; and
transmit the response to the payment network computing device.

13. The system of claim 12, wherein the personal identifying information for the user corresponds to personal identifying information for the user stored at and known to the verification party, whereby the verification party is able to identify the user and retrieve a reference biometric for the user based at least in part on matching the personal identifying information included in the request to enroll the verification party with the personal identifying information for the user stored at and known to the verification party, thereby permitting the verification party and/or the interface processor associated with the verification party to use the reference biometric to verify the sample biometric for the user.

14. The system of claim 10, wherein the data structure includes multiple verification parties enrolled for the user and associated with the attribute of the identity of the user; and
wherein the payment network computing device is configured, in order to determine that the verification party includes information about the user sufficient to respond to the query, to:
identify the verification party from the multiple verification parties based on a priority order of the verification party relative to the multiple verification parties; and
determine that the identified verification party includes information about the attribute of the identity of the user based on a linking of the attribute to the verification party in the data structure.

15. The system of claim 10, wherein the payment network computing device is further configured, prior to receiving the request for verification from the relying party, to:
receive, from the user, a request to enroll the verification party to the user, the request to enroll the verification party including a sample biometric for the user and personal identifying information for the user;
transmit the sample biometric and the personal identifying information for the user to the interface processor associated with the verification party;
receive verification of the sample biometric for the user;
generate the MPAN and the AgencyPAN based on the verification of the sample biometric for the user; and
transmit the AgencyPAN to the interface processor associated with the verification party and transmit the MPAN to a computing device associated with the user.

16. A non-transitory computer-readable storage medium comprising executable instructions for use in verifying attributes of user identities, which when executed by at least one processor of a payment network, cause the at least one processor to:
receive a request for verification of a user from a relying party interacting with the user, the request including a query related to an attribute of an identity of the user and a master payment account number (MPAN) specific to the user;
identify at least one verification party enrolled for the user based on the MPAN;
determine that the at least one verification party includes information about the user sufficient to respond to the query, thereby permitting the verification party to verify the identity of the user;
convert the MPAN to an agency payment account number (AgencyPAN) associated with the verification party;
submit the query along with the AgencyPAN to an interface processor associated with the verification party; and
receive a response to the query from the interface processor and transmit the response to the query to the relying party.

17. The non-transitory computer-readable storage medium of claim 16, wherein the executable instructions, when executed by the at least one processor, further cause the at least one processor to pass authorization messages for payment account transactions between merchants and banks, the authorization messages each including a payment account number having a specific format; and
wherein the MPAN and the AgencyPAN each has the specific format, whereby, based on said specific format, the MPAN and the AgencyPAN are consistent with a payment account number to the payment network computing device.

18. The non-transitory computer-readable storage medium of claim 16, wherein the executable instructions, when executed by the at least one processor, further cause the at least one processor, prior to receiving the request for verification from the relying party, to:
receive, from the user, a request to enroll the verification party to the user, the request to enroll the verification party including a sample biometric for the user and personal identifying information for the user;
transmit the sample biometric and the personal identifying information for the user to the interface processor associated with the verification party;
receive verification of the sample biometric for the user;
generate the MPAN and the AgencyPAN based on the verification of the sample biometric for the user; and
transmit the AgencyPAN to the interface processor associated with the verification party and transmit the MPAN to a computing device associated with the user.

19. The non-transitory computer-readable storage medium of claim 18, wherein the personal identifying information for the user corresponds to personal identifying information for the user stored at and known to the verification party, whereby the verification party is able to identify the user and retrieve a reference biometric for the user based at least in part on matching the personal identifying information included in the request to enroll the verification party with the personal identifying information for the user stored at and known to the verification party, thereby permitting the verification party and/or the interface processor associated with the verification party to use the reference biometric to verify the sample biometric for the user.

20. The non-transitory computer-readable storage medium of claim 19, wherein the executable instructions, when executed by the at least one processor, further cause the at least one processor to:
receive an authorization request for a transaction by the user at the relying party to a payment account, wherein a payment account number for the payment account is different than the MPAN; and
transmit the authorization request to an issuer associated with the payment account.
